(19) United States
(12) Patent Application Publication
(10) Pub. No.: US 2011/0000588 A1
(43) Pub. Date: Jan. 6, 2011

(54) Continuous production system for magnetic processing of metals and alloys to tailor next generation materials

(75) Inventors: Alexander Bogicevic, Wolverine Lake, MI (US); Aquil Ahmad, West Bloomfield, MI (US); John A. Kovacich, Waukesha, WI (US); Bohdan Lisowsky, Troy, MI (US); Michael L. Killian, Troy, MI (US); Alaa A. Elmoursi, Troy, MI (US)

Correspondence Address: EATON CORPORATION;EATON CENTER, 1111 SUPERIOR AVENUE, CLEVELAND, OH, 44114, US

(73) Assignees: Alexander Bogicevic; Aquil Ahmad; John A. Kovacich; Bohdan Lisowsky; Michael L. Killian; Alaa A. Elmoursi

(21) Appl. No.: 12/459,323

(22) Filed: Jul. 1, 2009

(51) Int. Cl. C21D 1/04; B29C 67/00

(52) U.S. Cl. 148/559; 266/102; 266/103; 425/3; 264/427; 264/429

(57) ABSTRACT

A system and method for producing material characteristics are described. A magnetic treatment chamber with a high magnetic field treats workpieces; and a conveyor or transporter continuously moves the workpieces through the high magnetic field in the magnetic chamber. A frictional or mechanical engagement system extracts the workpieces through and out of the high magnetic field.

### CROSS-REFERENCE TO RELATED APPLICATIONS

This application is a utility patent application of provisional application U.S. Ser. No. 61/133,540, filed Jun. 30, 2008, in the name of Alex Bogicevic, Aquil Ahmad, Alaa Elmoursi, Bohdan Lisowski and Michael Killian for a “Continuous Production System for Magnetic Processing of Metals and Alloys to Tailor Next Generation Materials”, which is incorporated by reference herein in its entirety

### TECHNICAL FIELD

This description relates to a magnetic production system, and more particularly to a continuous production system for magnetically processed materials.

### BACKGROUND

Materials can be customized for specific applications by adjusting their properties. Magnetic treatment of materials can alter material characteristics. For example, magnetic treatment can be used to alter structural, magnetic, electrical, optical, acoustical, and tribological properties.

Magnetic treatment of materials can be applied in different forms as described next. Magnetic treatment can replace many existing treatments of materials. For example, hardening of materials, which is generally performed by heat treatment, can be done by magnetic treatment. For many materials, magnetic treatment can be used where other forms of treatment are not feasible. For example, alloys where solubility of certain materials is restricted due to thermodynamic limitations can be formed using magnetic treatments. In some applications, conventional heat treatment may not be useful to achieve desired material characteristics of microstructure and composition. Applications that require materials with particular strength, wear, ductility, and magnetic permeability may not be achievable by non-magnetic treatment such as heat treatment.

Magnetic treatment of materials has been used to vary material characteristics. Magnetic treatment can also be combined with existing treatment of materials to achieve specific material characteristics. For example, in U.S. Pat. No. 7,161,124 Kisner et al. describe techniques for altering characteristics of a workpiece which includes an electrically-conductive material. Further, the Kisner patent describes dual use of magnetic and thermal treatment on a workpiece to alter its material characteristics.

### SUMMARY

A material processing system for achieving specific material characteristics is described. Input materials or parts are treated in a magnetic field or a thermomagnetic zone. The magnetic field is of high strength, e.g., above 2 Tesla. The input materials or feed stock parts are continuously moved over a transport mechanism like a conveyor belt. The parts can be positioned in the treatment chamber using grips and can also be positioned using rotational, translational or other motion source. A quenching mechanism can be used to quench parts after the thermomagnetic treatment. The quenching mechanism can be integrated with the thermomagnetic processing system and the conveyor belt that moves the parts.

### DESCRIPTION OF THE DRAWINGS

FIG. 1 shows a schematic cross-sectional view of an exemplary continuous production system for material processing;

FIG. 2 shows a schematic cross-sectional view of an exemplary magnetic processing system;

FIG. 3 shows a schematic cross-sectional view of an exemplary magnetic processing system's application to relatively large sized parts;

FIG. 4 shows a cross-sectional schematic view of an exemplary mechanical engagement for conveyor movement in the magnetic treatment system;

FIG. 5 shows a cross-sectional schematic view of an exemplary friction engagement for conveyor translation in the magnetic treatment system;

FIG. 5A shows a cross-sectional view of an exemplary rotational workpiece handling system;

FIG. 5B shows a cross-sectional view of an exemplary translational workpiece handling system; and

FIG. 6 shows a cross-sectional schematic view of an exemplary magnetic system with a quenching mechanism.

### DETAILED DESCRIPTION

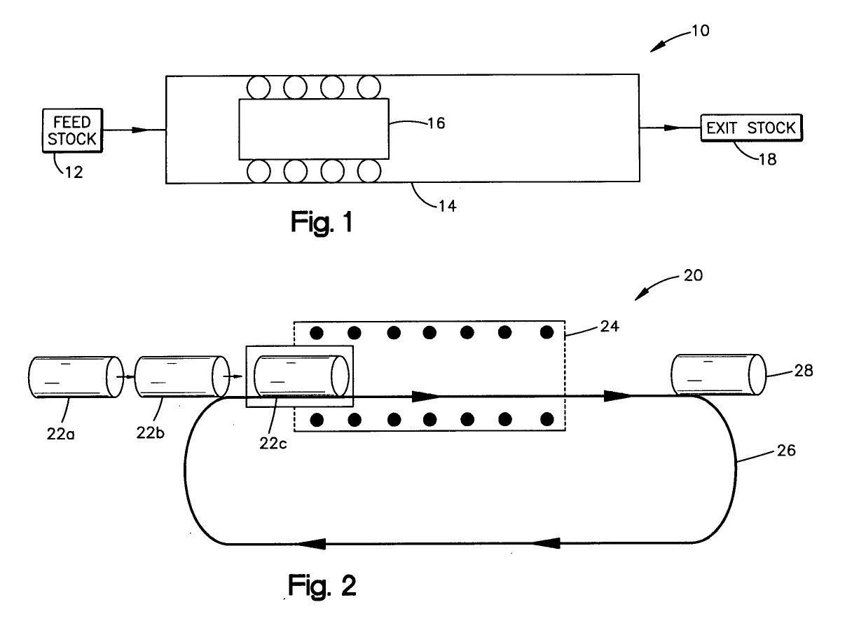

FIG. 1 shows a cross-sectional schematic view of an exemplary continuous production system for material processing. A continuous processing system 10 receives the feed stock 12 to be treated. Feed stock 12 can be a variety of materials. In one instance, the feed stock 12 can be an alloy material capable of producing the desired metallurgical and mechanical properties for a given end product. The properties of the alloy can be tailored to meet the specific demands of strength, wear, ductility and magnetic permeability for a specific application.

The feed stock 12 can be of different physical and structural forms. For example, feed stock 12 could be separate parts, linked parts, or continuous materials such as rods, bar stock, wire, plate, chain, sheet, etc. An example of the feed stock 12 could be steel (SAE 8600 series or other), that is magnetically treated using the system and process described here to achieve improvements in mechanical properties of a transmission gear formed using the steel feed stock. The transmission gear characteristics can be improved using magnetic treatment. For example, the gear's mechanical properties such tensile strength and wear can be improved by magnetic treatment.

Feed stock 12 can be sourced as a relatively lower cost material to achieve characteristics of relatively higher cost materials. For example, feed stock 12 can be relatively low cost steel, e.g., SAE 1215, which when magnetically treated in a continuous manner as described here yields improved characteristics of magnetic permeability, low magnetic coercivity and improved magnetic saturation that are comparable to more expensive grades of electrical steel.

Other examples of feed stock 12 that can be used are described next. For example, the feed stock 12 can be tool steel which when processed in a magnetic field will provide relatively superior temperature performance, e.g., improved creep resistance. In another example, the feed stock 12 can be stainless steel or cast iron that when continuously magnetically processed will yield better application performance for applications that use the treated stainless steel or cast iron. Other examples of alloys that can be treated include alloys of nickel, copper, and cobalt which when processed will generate unique microstructures and properties for a desired application.

The feed stock 12 can be a variety of materials, for example, the feed stock 12 can be ferrous or non-ferrous materials that can be treated magnetically to achieve desired characteristics for such materials. Feed stock 12 can be ferromagnetic, non-ferromagnetic, other magnetic state types, compounds, alloys, variable gradient materials, surface engineered gradient-compound materials, metals, non-metals, semiconductors, insulators, ceramics, engineered materials, nano-materials, composite materials, magnetic particle materials, crystalline and poly-crystalline materials having crystal plane orientation and anisotropic properties of materials, inorganic materials, organic and polymer materials, crystalline and amorphous materials, etc. Those skilled in the art will appreciate that above examples illustrate the use of continuous magnetic treatment described here, while other applications are also possible.

The treatment chamber 14 can be used to achieve magnetic or the other kinds of processing. The treatment chamber 14 can be used for magnetic, thermomagnetic, induction hardening, heat treatment, integrated, non-integrated, quenched or other kinds of standard material processing treatments. These treatments can be applied as stand-alone treatments or be used in combination with other treatments.

Magnetic treatment of the feed stock 12 is described next. Magnetic field processing of materials requires treating of target materials in a magnetic field. One approach to achieving the required magnetic field strength is by the use of electromagnets. Solenoid coils 16 form an electromagnet when the coils are energized. High magnetic fields, e.g., about 2 to 30 Tesla or higher, are used to alter material properties in the magnetic processing system 10. In one approach, such high magnetic field can be generated by a superconducting solenoid coil (cooled using a cryostat system). The feedstock 12 can be subject to pre-cleaning or other preparatory processes.

A treatment chamber 14 provides a chamber for magnetic treatment of the feed stock 12. The treatment chamber 14 includes solenoid coils 16 that generate magnetic field. The treatment chamber 14 includes mechanism to move the feed stock 12 through the treatment chamber 14. Any mechanism (not shown) can be used to move the feed stock 12 through the treatment chamber 14. For example, conveyors, worm-gear drives or linear actuators could be used. During the movement process, the feed stock 12 can be treated magnetically to alter its material properties. The feed stock 12 departs the magnetic chamber 14 as exit stock 18. The continuous treatment of the feed stock 12 through the treatment chamber 14 is used to alter the material properties of the feed stock 12 to achieve the exit stock 18.

The treatment chamber 14 forms part of an extraction system that continuously moves workpieces or samples of the feed stock 12 through the magnetic field. The extraction forces (not shown) can be up to 2000 pounds or more depending on: (1) the rate of passage of the materials or parts through the magnetic field, and (2) the strength of the magnetic field in the treatment chamber 14. The role of extraction forces is to overcome the magnetic field imposed on the part being processed. The extraction forces in the treatment chamber 14 will depend on sample geometry and size among other factors. Axial and cross-axis extraction forces would need to be controlled through continuous sample handling. Extraction forces can be supplied via electrical motor/actuation, hydraulic motor/actuation, or electro-hydraulic motor/actuation.

Continuous magnetic treatment processing reduces processing time as compared to treating each workpiece individually. This in turn leads to lower cost for treating materials or parts. Continuous magnetic treatment process as described here can be used to treat basic materials to create wires, rods and other such materials that facilitate further forming processes (e.g., forging, machining, bending, etc). The wires, rods and other such materials can be further treated magnetically in a continuous manner to improve formability. These improved materials and parts would require lower forming temperatures, lower energy consumption and longer tool life. Another example would be continuous billet casting process that uses the continuous magnetic treatment system described here. The billets casted with magnetic treatment will reduce segregation of inclusions and provide relatively more uniform microstructure and isotropic mechanical properties of the billets.

Alloys where solubility of some elements is restricted due to thermodynamic limitations can be made under the continuous magnetic processing described here. However, in certain cases where temperatures exceed the Curie temperatures in field operations, the magnetic treatment is inapplicable. The continuous magnetic treatment can be combined with or used in conjunction with other standard deformation methods, hardening methods, post treatment methods, etc, operating under a magnetic field or outside the magnetic field.

FIG. 2 shows a cross-sectional schematic view of an exemplary magnetic processing system 20. The magnetic processing system can be either a standalone magnetic system or a combination of heat treatment and magnetic treatment. Magnetic treatment can be applied simultaneously with the heat treatment or sequentially. Unprocessed parts 22a-22c are representative of the parts that are fed into the system in a continuous manner. In one embodiment, a thermomagnetic system 24 includes an induction heating system (not shown) and a magnetic treatment system, e.g., the solenoid coils 16 (See FIG. 1) to generate a thermomagnetic zone. The thermomagnetic system 24 alters the properties of the parts 22a-22c by thermal and magnetic treatment to generate finished parts, which are represented by a single finished part 28 shown in FIG. 2.

The thermomagnetic system 24 continuously provides twin treatments of thermal and magnetic forces to the representative parts 22a-22c as described next. Temperatures for induction hardening, induction heating and phase transformation within thermomagnetic processing can range from low temperatures (e.g, about 200 degree Fahrenheit) for quench mechanism, tempering, low temperature transformation or low temperature thermomagnetic transformation, to high temperatures (e.g, about 2000 degree Fahrenheit) for thermomagnetic transformations. The thermomagnetic system 24 can be used for processing cryogenic temperatures in combination with cryo-treatment of the materials. This cryogenic treatment can be applied for both ferrous and non-ferrous materials.

A conveyor 26 moves the parts 22a-22c through the thermomagnetic system 24. Those skilled in the art will appreciate that the conveyor 26 is only illustrative of different mechanisms that can be used to transport the parts 22a-22c through the thermomagnetic system 24. The conveyor 26 moves the parts 22a-22c continuously through the thermomagnetic system 24, which process the parts 22a-22c continuously through a magnetic fields and heated zones or areas.

The representative parts shown here, 22a-22c, are shown as cylinders for exemplary purpose, any other kind of parts can be processed through the thermomagnetic system 24. The exemplary parts 22a-22c show how relatively smaller parts can be continuously processed in the thermomagnetic processing system 24. As the parts 22a-22c exit through the thermomagnetic processing system 24's magnetic field, magnetic forces that were operating on the parts 22a-22c are overcome. The thermomagnetic processing system 24's magnetic field can be generated using a superconducting magnet (not shown). The superconducting magnet's magnetic field would keep the part at the center of that field through that magnetic force. Therefore, extraction forces are required and are provided by the conveyer mechanism to move that part out of the magnetic field area.

Control of heat treatment enables creation of materials with variable properties in their different dimensions. Certain applications require complex heat treatment, e.g., having different hardness in different regions of a part. For example, a gear (not shown) can require certain hardness for its teeth on the OD (Outer Diameter) and different hardness for splines on the ID (Inner Diameter). The thermomagnetic system 24 can include induction coils (not shown) that enable treatment to create parts like the last mentioned gear with variable hardness mentioned last using different frequencies.

The thermomagnetic system 24 can be used for continuous treatment of surface coatings and coated deposits. For example, some of the surface coating treatments that can be continuously treated are: Chemical Vapor Deposition (CVD), Physical Vapor Deposition (PVD), laser deposition, plasma transfer arc deposition, plating, plasma deposition, evaporation deposition, sputtering, ion beam deposition, reactive plasma deposition, or chemical beam epitaxial deposition. Surface coating treatment can be done as a function of the heat treatment, thermomagnetic processing or magnetic processing. For example, treatment of the surface coating could be a coating that gets transformed for improved performance (wear, ductility, lubricity, etc.). Those skilled in the art will appreciate that the surface coatings mentioned here are exemplary and other surface coating treatment using the continuous treatment are possible.

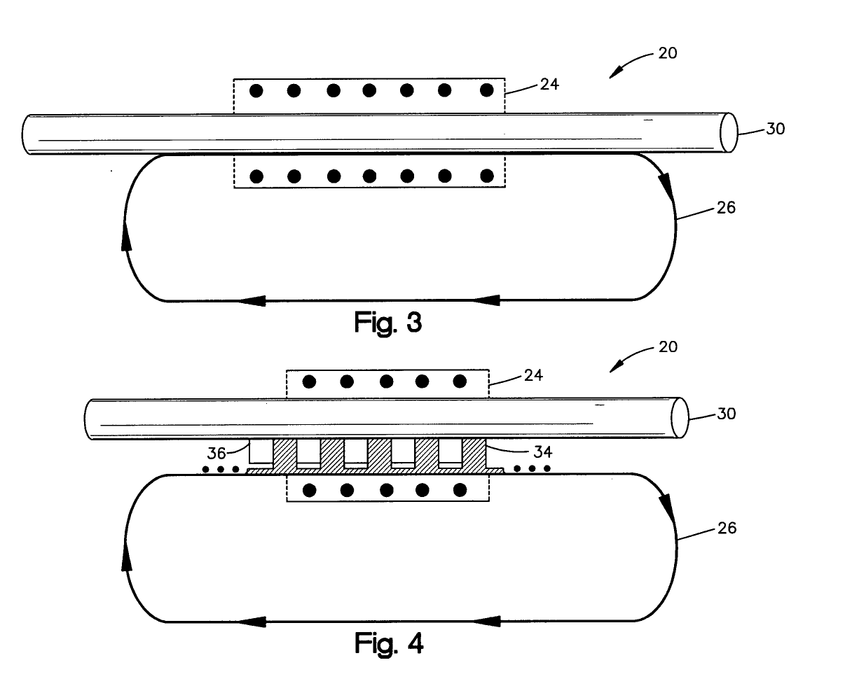

FIG. 3 shows a cross-sectional schematic view of an exemplary magnetic processing system's application to relatively large sized parts. In FIG. 2, exemplary parts 22a-22c were shown as being relatively small parts. Here, thermomagnetic processing for large parts is described. Large parts can be in forms such rods, wires, blocks, etc. Treating such parts as individual pieces can be difficult due to the size of treatment chambers required. Continuous processing of such large parts is achieved here. For example, a relatively large sized rod 30 is moved over the conveyor 30. The thermomagnetic system 24 treats the rod 30 to alter its properties and achieve the desired microstructure in the rod 30. Additionally, thermal treatment can be combined to achieve thermomagnetic processing as described above in context of FIG. 2 with necessary modifications for large parts. Those skilled in the art will appreciate that rod 30 is shown here as an example, any large sized parts such as wires, rods, cylinders, blocks, and bar stock, etc., can be processed in a similar way.

FIG. 4 shows a cross-sectional schematic view of an exemplary mechanical movement for conveyor translation in the magnetic treatment system. A mechanically engaged magnetic treatment system 32 is used to treat the rod 30 to achieve the desired material properties. A magnetic field is provided by the thermomagnetic system 24 to treat the rod 30. Additionally, thermal treatment mechanism (not shown) can be included to achieve thermomagnetic treatment. The rod 30 is an example of parts or materials that can be treated. Those skilled in the art will appreciate that any sized parts or materials could be treated in a similar manner as the rod 30 in this example.

The conveyor 26 supports teeth 34 that engage with locking teeth 36. The locking teeth 36 support the rod 30. The teeth 34 and locking teeth 36 together form an interlocking system that is used to transport the rod 30 through the thermomagnetic system 24. During the transport, the rod 32 gets magnetically treated to alter its characteristics. The speed of movement of the conveyor 24 is controlled by the interlocking teeth mechanism formed by the teeth 34 and the locking teeth 36. The mechanically engaged magnetic treatment system 32 overcomes the magnetic forces through extraction forces as the rod 30 is transported out of the thermomagnetic system 24. The role of extraction forces is to overcome the magnetic field imposed on the part being processed. The rod 30 needs to be clamped, held or attached to the conveyor 26 so that it can be extracted from the magnetic field. If the rod 30 is not so clamped, held or attached to the conveyor 26, then to remove it from the magnetic field, the magnetic field will have to be switched-off. Hence, by clamping, holding or attaching the rod 30 to the conveyor 26 continuous magnetic or thermomagnetic processing can be achieved.

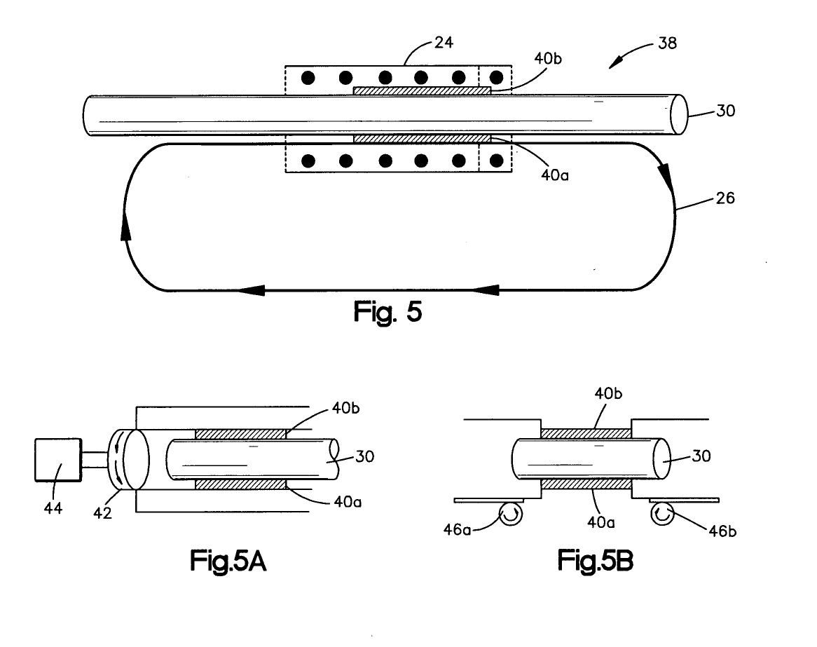

FIG. 5 shows a cross-sectional schematic view of an exemplary friction engagement for conveyor translation in the magnetic treatment system. A friction based magnetic treatment system 38 is shown. The rod 30 is held by a frictional holding mechanism. An exemplary friction based holding mechanism is shown here as gripping plates 40a-40b. Those skilled in the art will appreciate that the gripping plates 40a-40b are exemplary and other friction based mechanisms can also be employed to hold the rod 30 while the rod is moved by the conveyor 26.

FIG. 5A shows a cross-sectional view of an exemplary rotational workpiece handling system; and FIG. 5B shows a cross-sectional view of an exemplary translational workpiece handling system. Axial and cross-axis extraction forces need to be controlled through continuous sample handling as described next. The gripping plates 40a-40b can be attached to a rotating drum 42 that is driven by a motor 44 to provide rotational motion to the rod 30, which is an exemplary workpiece. The function performed by the exemplary friction plates 40a-40b represents one kind of rod handling mechanism. Another handling mechanism can include a mechanism to provide translational manipulation of the workpiece (e.g., the rod 30 here is a workpiece). Rollers 46a-46b and friction plates 40a-40b together can be used to provide translational motion for the rod 30 in multiple directions. Other kinds of workpiece handling mechanisms can be provided to achieve the desired properties in the workpiece.

The forces for translational, rotational, gripping or other workpiece manipulation can be provided by electric motor, electrical actuation, electro-hydraulic actuation, hydraulic actuation, etc. The forces provided by such sources can be used to orient the rod 30 or similar workpiece in various angles, directions or positions to achieve targeted treatment for the desired material characteristics. The forces for translational, rotational, gripping enable the workpieces to be extracted out of the magnetic field of the magnetic treatment system 38. The magnetic treatment system 38 can be used in conjunction with a thermal treatment system (not shown) to provide thermomagnetic treatment. The thermal treatment can be provided simultaneously with the magnetic treatment of the magnetic treatment system 38 or sequentially.

Workpiece handling described above enables specific material properties to be engineered in the workpieces. For example, rotational and/or translational manipulation of the workpiece in the magnetic field described above allows hardening and treatment of gear teeth, filet features, wear areas, ductile areas, surface treatment, bulk treatment on relatively complicated geometry workpieces

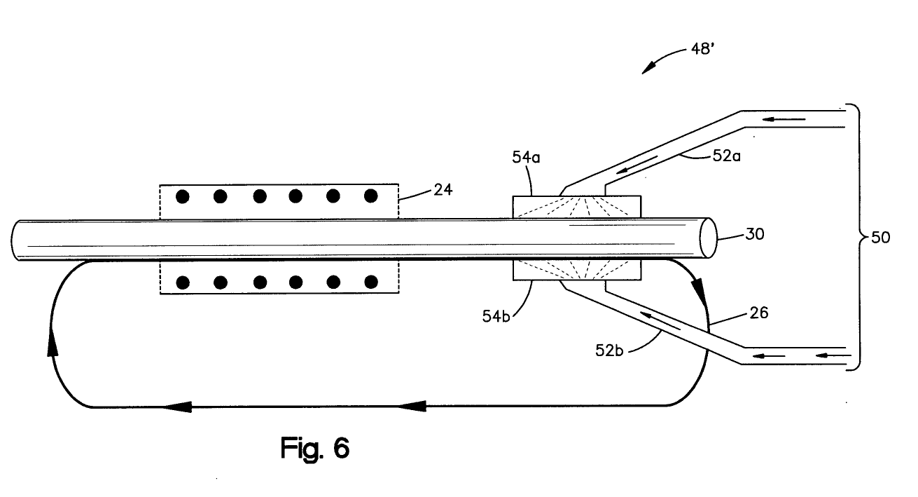

FIG. 6 shows a cross-sectional schematic view of an exemplary magnetic system with a quenching mechanism. A magnetic treatment system with a quenching system 48 includes the conveyor 26 and the thermomagnetic system 24. Additionally, a quenching mechanism 50 is included to provide rapid cooling for the rod 30 after it exits the thermomagnetic system 24. The quenching mechanism 50 includes quenching transporters 52a-52b that transport quenching materials to be used to treat the rod 30 and attached sprinklers 54a-54b that spray the quenching materials on the rod 30. The quenching materials that are sprayed can be gas, liquid or other type of quench medium.

Quenching process is used in conjunction with the combined heat and magnetic treatment of the exemplary rod 30 workpiece as described next. The quenching mechanism 50 is shown in a horizontal orientation. However, a vertical quenching mechanism is also possible with the thermomagnetic system 24, the conveyor 26, the quenching transporters 52a-52b and the sprinklers 54a-54b being oriented vertically as contrasted with the horizontal orientation shown in the FIG. 6. Those skilled in the art will appreciate that the choice of horizontal and vertical orientation of the magnetic system with a quenching mechanism 50 will depend on a particular application of the system to achieve desired material properties.

The placement of the quenching transporters 52a-52b and sprinklers 54a-54b within the quenching system 48 will depend on the configuration as described next. The quenching transporters 52a-52b and the sprinklers 54a-54b can be located at different positions in the quenching system 48. For example, they can be located in-situ with the thermomagnetic system 24, in a magnetic field associated with thermomagnetic processing (See FIG. 2 and related description above), outside the magnetic field of the thermomagnetic system 24, integrated with the conveyor 26 or separate from the conveyor 26. Quenching mechanisms can be gas, oil, polymer, water and other standard or non-standard approaches. Those skilled in the art will appreciate that the location of the quenching mechanism 50, quenching transporters 52a-52b and/or sprinklers 54a-54b will depend on the application and the results desired.

Temperature and magnetic profile can be varied along the continuous movement of the workpieces (shown here as the exemplary rod 30) on the conveyor 26. This enables proper transformation of the workpiece properties. Further, quenching process can be controlled with rapid or slower cooling to attain specific material properties in the workpieces. Continuous processing involves controlling movement rates and speeds of the workpieces through the temperature zones and magnetic profiles for specific times to provide the desired treatment characteristics.

Various aspects of the invention have been described in the foregoing specification, and it is believed that various alterations and modifications of the invention will become apparent to those skilled in the art from a reading and understanding of the specification. It is intended that all such alterations and modifications are included in the invention, insofar as they come within the scope of the appended claims.

What is claimed is:

1. A system for producing material characteristics in workpieces, the system comprising:
a magnetic treatment chamber, wherein the magnetic treatment chamber generates a high magnetic field;
a transporter for continuously moving the workpieces through the high magnetic field in the magnetic chamber; and
a frictional engagement system for extracting the workpieces through the high magnetic field, wherein the frictional engagement system is coupled with the transporter.

2. The system of claim 1, further comprising:
a thermal treatment system for thermally treating the workpieces.

3. The system of claim 2, wherein the thermal treatment system heats the workpieces positioned in the magnetic treatment chamber.

4. The system of claim 2, wherein the thermal treatment system heats the workpieces after the transporter has moved the workpieces through the magnetic treatment chamber.

5. The system of claim 1, wherein the high magnetic field has strength of at least 2 Tesla.

6. The system of claim 1, further comprising:
a quenching system for quenching heat from the workpieces.

7. The system of claim 6, wherein the quenching system comprising:
at least one sprinkler.

8. The system of claim 1, wherein the frictional engagement system comprising:
teeth, wherein the teeth grip the workpieces to the transporter.

9. The system of claim 1, wherein the frictional engagement system comprising:
at least one gripping plate, wherein the gripping plate holds the workpieces to the transporter.

10. The system of claim 1, wherein the frictional engagement system comprising:
a rotation mechanism, wherein the rotation mechanism rotates the workpieces in the magnetic treatment chamber.

11. The system of claim 1, wherein the frictional engagement system comprising:
a translation mechanism, wherein the translation mechanism positions the workpieces in the magnetic treatment chamber in at least two directions.

12. A system for producing material characteristics in workpieces, the system comprising:
a thermomagnetic treatment system, wherein the thermomagnetic treatment system generates a thermomagnetic zone;
a transporter for continuously moving the workpieces through the thermomagnetic zone in the thermomagnetic chamber;
a grip, wherein the grip positions the workpieces in the thermomagnetic zone; and
a quenching system for quenching heat from the workpieces.

13. The system of claim 12, wherein the grip comprising:
a rotational handler, wherein the rotational handler rotates the workpieces held in the grip within the thermomagnetic zone.

14. The system of claim 12, wherein the grip comprising:
a translational handler, wherein the translational handler translates the position of the workpieces held in the grip within the thermomagnetic zone in at least two directions.

15. The system of claim 12, wherein the thermomagnetic system comprises:
a solenoid coil, wherein the solenoid coil generates a high magnetic field; and
an induction heater, wherein the induction heater generates heat.

16. The system of claim 12, wherein the quenching system comprising:
at least one sprinkler.

17. A method for producing material characteristics in workpieces, the method comprising:
treating the workpieces in a magnetic field continuously;
processing the workpieces in a thermal area;
positioning the workpieces in the magnetic field; and
moving the workpieces through the use of a transporter through the magnetic field and the thermal area.

18. The method of claim 18, wherein the step of positioning comprising:
rotating the workpieces.

19. The method of claim 18, wherein the step of positioning comprising:
moving the workpieces in translational positions.

20. The method of claim 18, further comprising:
quenching the workpieces.
